(19) United States
(12) Patent Application Publication
(10) Pub. No.: US 2006/0283961 A1
(43) Pub. Date: Dec. 21, 2006

(54) Method for recording identification information on semiconductor chip, and imaging device

(75) Inventors: Takeshi Misawa, Saitama (JP); Maki Saito, Miyagi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/453,007

(22) Filed: Jun. 15, 2006

(30) Foreign Application Priority Data
Jun. 15, 2005 (JP) 2005-175074

(51) Int. Cl. G06K 19/06

(52) U.S. Cl. 235/492

(57) ABSTRACT

On a wafer coated with photosensitizing agent, plural shots of exposure are applied through a mask including a plurality of reticles each of which has a circuit pattern and a top surface identification information, while the mask and the wafer are relatively moved. Then the wafer is developed and etched to form convex or concave reticle numbers (top surface identification information) on a metal layer which is the uppermost part or a part close to the uppermost part of the wafer. The reticle numbers enables to distinguish each of reticles on the mask. Next, an under surface identification information is recorded on an under surface of the wafer by laser marking or another method. The under surface identification information enables to distinguish each of the shots of exposure.

### BACKGROUND OF THE INVENTION

1. Field of the Invention

The present invention relates to a method for recording identification information on a semiconductor chip, and relates to an imaging device which packages an image sensor chip having the recorded identification information.

2. Description Related to the Prior Art

In many semiconductor devices, a semiconductor chip is contained in a package, and input/output pads of the semiconductor chip are connected to leads of the package through bonding wires. A hollow package is known as one of the package.

The hollow package comprises a box-like package body formed of a ceramic or a plastic and having a chip chamber of recessed-shape on a top surface thereof, leads provided in the package body by insert molding, and a cover attached on the top surface of the package body to seal the chip chamber. Recently, bumps are often used instead of the bonding wires to connect between the semiconductor chip and the leads. In an imaging device having an image sensor chip such as CCD or CMOS contained in the hollow package, the cover is made of a transparent material.

To distinguish each of the plural semiconductor chips, identification information, which includes information such as product number and lot number, is recorded on the surface of the semiconductor chip. For example, Japanese Patent Laid-Open Publication No. 57-179849 discloses a method in which a mask with a plurality of reticles including a circuit pattern and individual identification information is used, and plural shots of exposure are applied on a top surface of a wafer through the mask while a position of the wafer is changed on each shot. Through development, plural, circuit patterns and identification information are formed on the wafer. In addition, Japanese Patent Laid-Open Publication No. 04-106960 discloses a method in which identification information of each semiconductor chip is recorded by laser marking or the like on an under surface of a wafer having a top surface on which semiconductor circuits are formed.

However, on the top surface of the image sensor chip there is a light receiving section, which occupies large proportions of total area of the top surface of the chip. Accordingly, when the method of Japanese Patent Laid-Open Publication No. 57-179849 is used, maximum amount of information that can be recorded on the top surface of the chip is small because of small space for recording the information. Specifically, since only position information of circuit patterns (image sensor chips) exposed in a single shot can be recorded with this method, the image sensor chips cannot be distinguished from each other.

In the method of Japanese Patent Laid-Open Publication No. 04-106960, there is a problem that recording detailed identification information to each chip by the laser marking or the like requires long time, which reduces efficiency of manufacturing. In addition, there is further problem that the identification information recorded on the under surface of the chip is invisible after the image sensor chip is contained in the hollow package.

### SUMMARY OF THE INVENTION

A main object of the present invention is to provide a method for recording identification information on semiconductor chips, which enables to distinguish each semiconductor chip and to perform effective recording of the identification information,on the semiconductor chip in view of time and space.

Another object of the present invention is to provide an imaging device, in which identification information on a semiconductor chip contained in a hollow package is visible.

In order to achieve the above objects and other objects, a method for recording identification information on semiconductor chips of the present invention comprises a patterning process, a marking process and a dicing process. In the patterning process, a top surface of a wafer receives plural shots of exposure, through a mask including a plurality of reticles each of which has a circuit pattern and a top surface identification information, while the mask and the wafer are relatively moved. Then the wafer is developed to form the circuit patterns and the top surface identification information on a metal layer which is the uppermost part or a part close to the uppermost part of the wafer. In the marking process, an under surface identification information is recorded on an under surface of the wafer. In the dicing process, the wafer is cut into plural pieces of the semiconductor chips. The top surface identification information enables to distinguish the semiconductor chips on the basis of the reticles, and the under surface identification information enables to distinguish the semiconductor chips on the basis of the shots.

The top surface identification information and the under surface identification information are preferably letters, numerals, symbols or combinations of them, for easy interpretation of the information. Alternatively, the under surface identification information may be plural barcodes arranged in different directions. In this construction, readability of the information is improved when the information is read by a reader such as a barcode reader.

As a method for recording of the under surface identification information, a laser marking, ink-jet and so on can be used. In the ink-jet method, the ink preferably has heat-resistance and water-resistance, so that the identification information is prevented from being removed by heat in dicing or cooling water.

As the semiconductor chip, an image sensor chip having a light receiving section on its top surface is preferable for the present invention. As the image sensor chip, both of CCD type and CMOS type can be used.

An imaging device of the present invention comprises an image sensor chip having a top surface provided with a light receiving section and an under surface provided with identification information, a package body having a chip chamber on a top surface thereof for containing the image sensor chip, an opening penetrating through between an under surface of the package body and a bottom surface of the chip chamber, and a transparent cover for sealing the chip chamber. The identification information on the under surface of the image sensor is visible through the opening. In addition, the opening may be sealed with a transparent sealing plate not to lose the visibility of the identification information.

According to the method for recording identification information on semiconductor chips of the present invention, since the identification information can be recorded both on the top and under surfaces of the wafer, maximum amount of information that can be recorded can be increased. Since the recording on the top surface is performed by exposure through the mask, the identification information and the circuit pattern can be exposed at the same time. Accordingly, a number of manufacturing processes is, not increased. Since the identification information on the under surface of the wafer is recorded on the basis of the shot of exposure on the top surface of the wafer, the time required to record the information can be shortened as compared with recording the identification information chip by chip. In addition, since each of the semiconductor chips can be distinguished from each other on a single shot basis and a single reticle basis by referring the identification information recorded on the top and under surfaces thereof, distinction of the semiconductor chip can be improved. In this configuration, the recording of the identification information on the semiconductor chip is carried out effectively in view of time and space, and the cost for manufacturing the semiconductor chips is not increased.

According to the imaging device of the present invention, since the identification information recorded on the image sensor chip is visible in the hollow package, number of items of identification information recorded on an outer surface of the package body can be reduced, or the identification information on the package body can be omitted.

### BRIEF DESCRIPTION OF THE DRAWINGS

The above objects and advantages of the present invention will become easily understood by one of ordinary skill in the art when the following detailed description would be read in connection with the accompanying drawings.

FIG. 1A and FIG. 1B are perspective views illustrating an appearance of an image sensor chip of the present invention, where FIG. 1A shows a top surface, and FIG. 1B shows an under surface;

FIG. 2 is a flowchart illustrating manufacturing procedures of the image sensor chip;

FIG. 3 is a schematic view illustrating a composition of a stepper;

FIG. 4 is an explanatory view showing an example of reticles on a mask;

FIG. 5 is an explanatory view showing shot positions of exposure on a wafer;

FIG. 6 is an explanatory view showing an example of under surface identification information recorded on an area corresponding to the exposure area of one shot on the wafer;

FIG. 7A and FIG. 7B are explanatory views illustrating the under surface identification information of barcodes, where FIG. 7A shows an under surface of the wafer, and FIG. 7B shows an under surface of the image sensor chip;

FIG. 8 is a schematic view of an example in which an ink-jet printer is used for recording the under surface identification information on the under surface of the wafer;

FIG. 9 is a cross-sectional view of an imaging device whose under surface has an opening;

FIG. 10 is a bottom plan view of the imaging devise shown in FIG. 9;

FIG. 11 is a cross-sectional view of an imaging device in which an opening on an under surface thereof is sealed by a sealing plate; and

FIG. 12 is a cross-sectional view of an imaging device having a package body formed of transparent material.

### PREFERRED EMBODIMENTS OF THE INVENTION

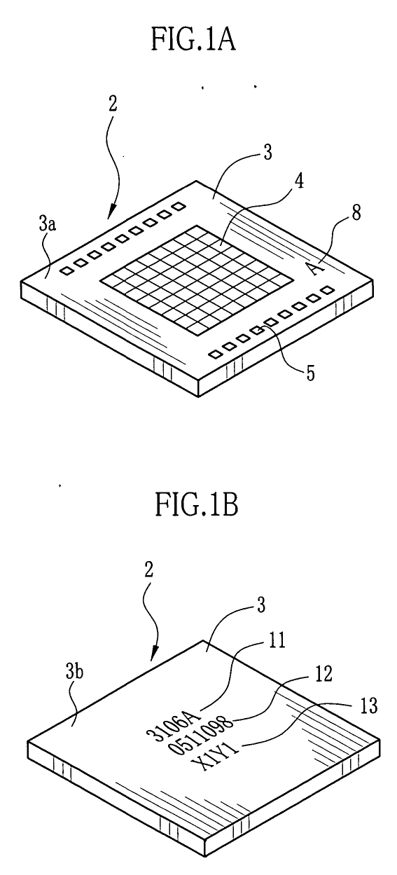

As shown in FIG. 1A and FIG. 1B, in an image sensor chip 2 which is for example a CCD ship, a light receiving section 4 and a plurality of input/output pads 5 are formed on a top surface 3a of a chip substrate 3 made of silicon or the like. In the light receiving section 4, plural photodiodes (PD) are arranged in a matrix, and color filters and microlenses are provided above the photodiodes. The input/output pads 5 are formed of a conductive metal, and electrically connected to the light receiving section 4.

On the top surface 3a of the chip substrate 3 and lateral to the light receiving section 4, a reticle number 8 as identification information is provided. The reticle number 8 represents a position of a reticle on a mask used for forming circuit patterns on a wafer through exposure.

On an under surface 3b of the chip substrate 3, a product code 11, a manufacture code 12, and a shot position code 13 are recorded as identification information. The product code 11 represents a product model number of the image sensor chip 2. The manufacture code 12 represents a lot number and a wafer number of the image sensor chip 2. The shot position code 13 represents a position of each shot on the wafer, when plural shots of exposure are applied on the wafer through the mask while a position of the wafer is changed on each shot. These codes enable to specify the kind, performance, manufactured time, manufacturing factory, manufacturing facility and so on of the image sensor chips 2, and to individually distinguish the base wafer, the position on the wafer and so on of each image sensor chip 2. This is highly beneficial for product management. Note that the product code 11, which is frequently checked, may be recorded on the top surface 3a of the chip substrate 3 where the code becomes more easily to be seen.

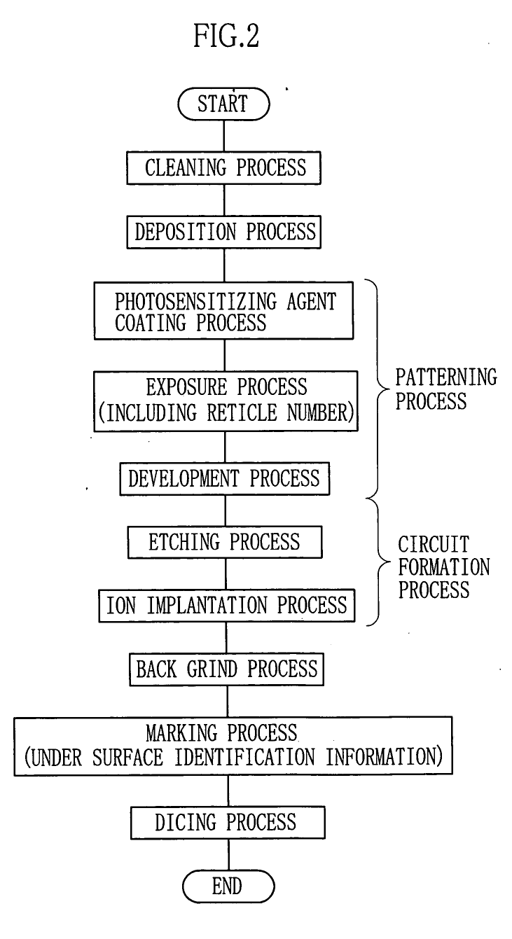

As shown in FIG. 2, the semiconductor chip such as the image sensor chip 2 is formed generally through a cleaning process for cleaning the wafer with use of plural kinds of chemicals and pure water, a deposition process for forming a layer of oxide silicon or aluminum on the top surface of the wafer by sputtering, CVD, thermal oxidation or the like, a patterning process for forming the circuit pattern on the top surface of the wafer, a circuit formation process for forming the semiconductor circuit on the top surface of the wafer by etching and ion implantation, a back grind process for grinding the under surface of the wafer to reduce the thickness of the wafer, and a dicing process for cutting the wafer into individual chips each of which has the semiconductor circuit. In the present invention, the identification information on the top surface (top surface identification information) is recorded in the pattering process, and the identification information on the under surface (under surface identification information) is recorded in a marking process provided between the back grind process and the dicing process.

The patterning process is comprised of a photosensitizing agent coating process for coating photosensitizing agent on the top surface of the wafer by a spin coater or the like, an exposure process for exposing the circuit pattern on the top surface of the wafer, and a development process for developing the top surface of the wafer to form the circuit pattern thereon.

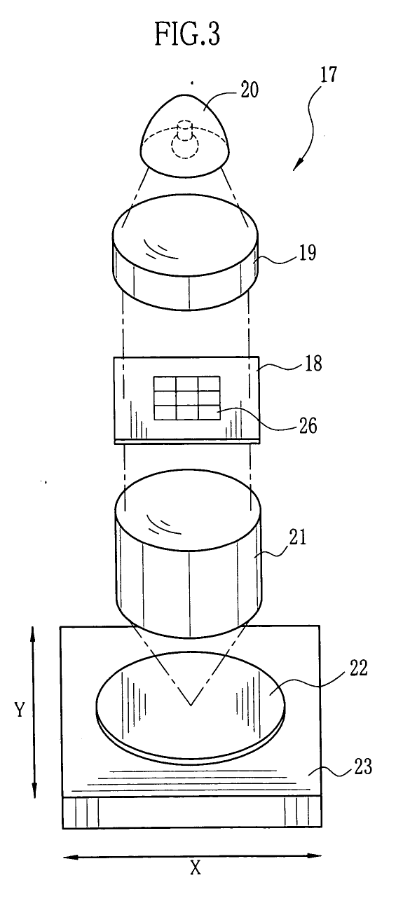

A stepper 17 shown in FIG. 3 is also called a reduction projection exposure device. In the stepper 17, a mask 18, including plural reticles 26 formed on a transparent board such as a glass board, is used. Each reticles 26 has a circuit pattern. The mask 18 is illuminated by a light source 20 through a condenser lens 19, and the light passed through the mask 18 is reduced and projected on a photosensitizing agent layer of a top surface 22a of a wafer 22, by a projection lens 21. A wafer stage 23, on which the wafer 22 is set, can move along X and Y directions in FIG. 3. Since the Wafer 22 is moved with respect to the projection optical system and the exposure is repeated, the circuit patterns can be applied on entire area of the top surface 22a of the wafer 22. The mask 18 and the projection optical system may be moved in the exposure process, instead of the wafer stage 23.

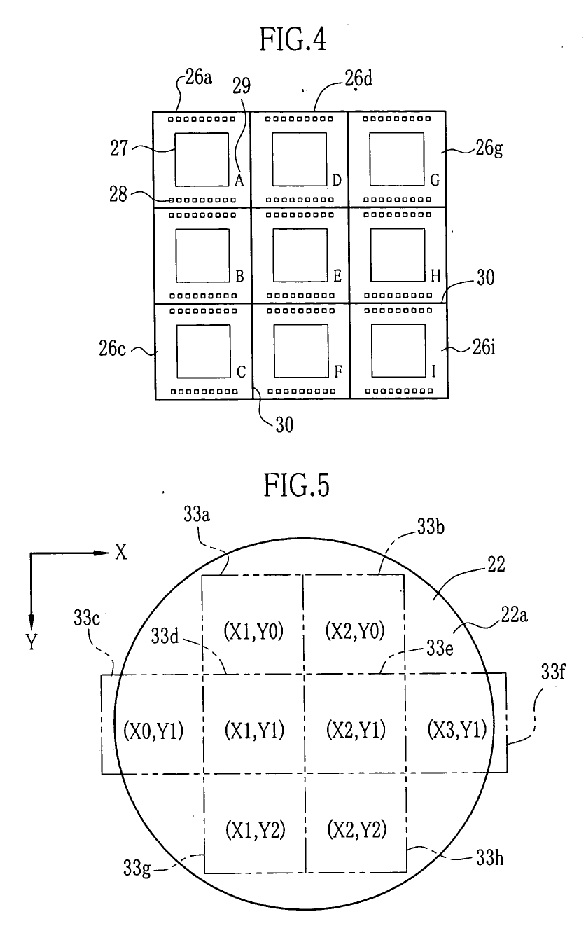

As shown in FIG. 4, for example nine reticles 26a to 26i arranged in a matrix are provided on the mask 18. Note that the number of reticles in the single mask 18 is not limited to 9, and may be changed according to sizes of the wafer and chip and performance of a stepper used in the exposure. Each of the reticles 26a to 26i is provided with a pattern 27 forming the light receiving section 4 of the image sensor chip 2, a pattern 28 forming the input/output pads 5, and a pattern 29 forming the reticle number 8. The pattern 29 of the reticle number 8 is each of alphabets A to I, which corresponds to each of reticles 26a to 26i. In addition, between the reticles 26a to 26i, there is a pattern 30 of a dicing line for cutting the wafer 22.

When the top surface 22a of the wafer 22 is exposed through the mask 18 and is developed, a resist having a shape of the reticle number 8 is remained on the top surface 22a. Then the wafer 22 is etched to remove a portion not covered by the resist. Accordingly, the convex reticle number 8 is formed on a metal layer which is the uppermost part or a part close to the uppermost part of the wafer 22. Note that if the exposure and development are performed such that a resist having a shape of the reticle number 8 is removed, the concave reticle number 8 is formed.

FIG. 5 shows shot positions 33a to 33h and their coordinates for performing plural shots of exposure on the wafer 22 by the stepper 17. In this coordinate system, X-axis represents horizontal direction and Y-axis represents vertical direction in the figure, and Y-coordinate value increases from upward to downward in the figure. According to this coordinate system, the coordinates of the shot position 33a are “X1, Y0”, and those of the shot position 33h are “X2, Y2”.

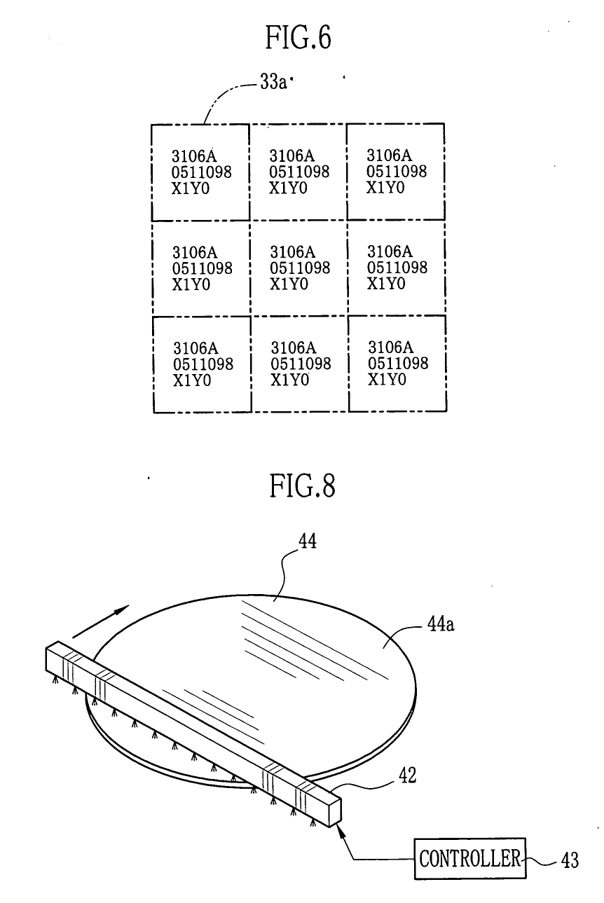

FIG. 6 shows the under surface identification information recorded in the shot position 33a on the under surface of the wafer 22. The under surface identification information is recorded on the basis of the shots, and the product codes 11, the manufacture codes 12 and the shot position codes 13 are identical in each shot position. Note that the product codes 11 and the manufacture codes 12 are identical in all over the wafer 22, and the shot position codes 13 are different according to the shot position.

To record the under surface identification information, a laser marking device is used. As the laser marking device, there are a scan type and a mask type. The scan type, which can easily change characters (such as letters, numerals and symbols) for marking, is suitable in consideration of change of the shot position code 13 on the shot basis. However, to reduce the time for marking, the mask type is preferable.

After the marking process, the wafer 22 is set on a dicing device to be cut along the dicing lines. That is, the plural image sensor chips 2 are cut off from the wafer 22. Each image sensor chip 2 informs the product type through the product code 11, and informs the lot number and the wafer number through the manufacture code 12. In addition, by referring to the shot position code 13 and the reticle number 8, the position of each image censor chip 2 on the wafer 22 is identified. Such information allows the effective product management of the image sensor chip 2.

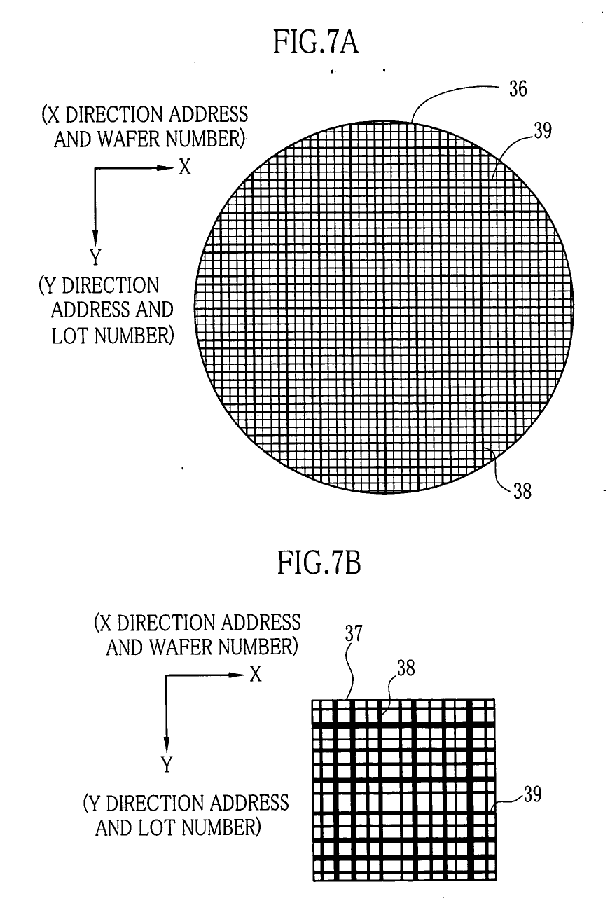

In the above embodiment, the under surface identification information is characters. However, barcodes may be used for the under surface identification information. For example, as shown in FIG. 7A and FIG. 7B, two types of barcodes 38 and 39 are recorded in X-direction and Y-direction on the under surface of the wafer 36 and the image sensor chip 37. In this case, the barcode 38 in X-direction preferably represents X-direction address and the wafer number, and the barcode 39 in Y-direction preferably represents Y-direction address and the lot number. The product code is preferably recorded on the top surface of the wafer 36.

Since the barcodes 38 and 39 are recorded in different directions each other, the barcodes can be printed large to improve readability, and the amount of information can be increased. Note that the information can be represented by a linear barcodes. In addition, two-dimensional barcodes can be used.

Although the laser marking is suitable for processing a semiconductor because dusts are not generated in the process, it cannot be used to process some kinds of semiconductor chips because it gives heat to a part of the wafer. In such case, as shown in FIG. 8, an ink-jet printer having a linear ink-jet head 42 and a controller 43 for the head 42 may be used. The identification information is recorded on an under surface 44a of a wafer 44 while the ink-jet head 42 or the wafer is moved. The ink preferably has heat-resistance and water-resistance, so that the identification information is prevented from being removed by heat in dicing or cooling water.

In the above embodiments, the under surface identification information is directly recorded on the under surface of the wafer. However, a media with recorded identification information may be attached to the wafer. For example, a label with recorded identification information of characters or barcodes, an IC tag with recorded identification information can be attached to the under surface of the wafer.

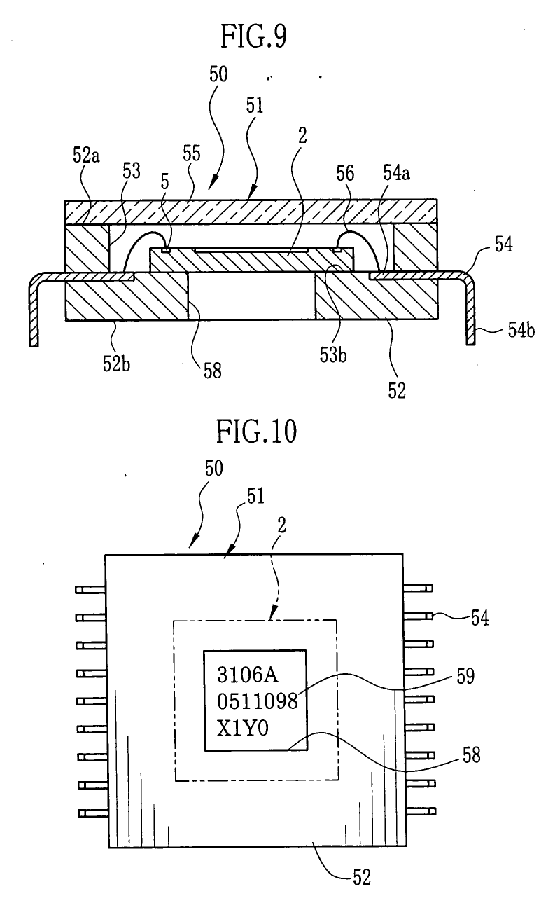

As shown in FIG. 9, an imaging device 50 comprises the image sensor chip 2 provided with the identification information on the top and under surfaces thereof, and a hollow package 51 for containing the image sensor chip 2. The hollow package 51 includes a box-like package body 52 formed of a ceramic or a plastic, a chip chamber 53 of recessed-shape on a top surface 52a of the package body 52, metal leads 54 provided in the package body 52 by insert molding, and a cover 55 attached on the top surface 52a of the package body 52 to seal the chip chamber 53. The cover 55 is a transparent glass or plastic plate to allow light to enter the image sensor chip 2.

One end of each lead 54 is an inner lead portion 54a exposed in the chip chamber 53, and the other end of each lead 54 is an outer lead portion 54b extending outside the package body 52. The input/output pads 5 of the image sensor chip 2 and the inner lead section 54a of the leads 54 are connected through bonding wires 56. Bumps may be used to connect between the image sensor chip 2 and the leads 54, instead of the bonding wires 56.

Between an under surface 52b of the package body 52 and a bottom surface 53b of the chip chamber 53, a penetrated opening 58 is formed. As shown in FIG. 10, the dimension of the opening 58 is smaller than the overall size of the image sensor chip 2, and is larger than the size of an identification information recording area 59 of the under surface of the image sensor chip 2, such that the identification information on the image sensor chip 2 can be visually checked from outside the hollow package 51. In the imaging device 50 of the present invention, since the identification information recorded on the image sensor chip 2 is directly viewable, there is no need to record identification information of the image sensor chip on an under surface or another portion of the package body which contains the image sensor chip.

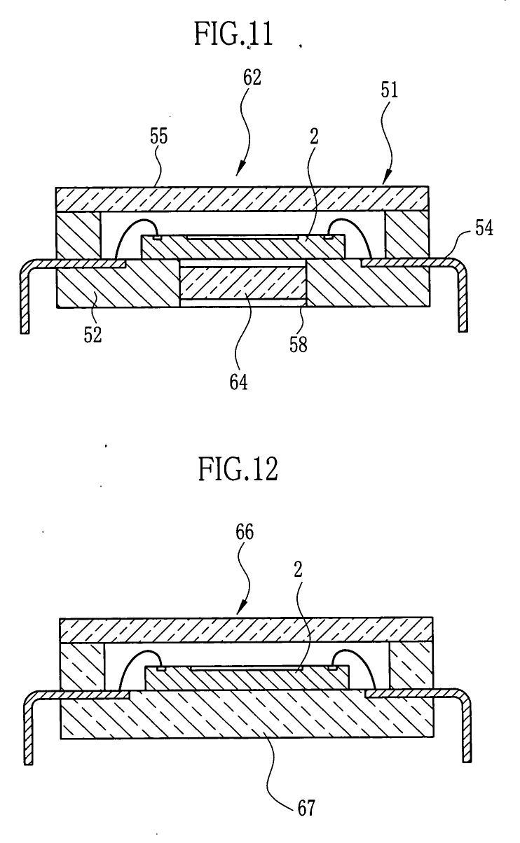

As an imaging device 62 shown in FIG. 11, a transparent sealing plate 64 may be fitted into the opening 58. According to this construction, it is prevented that foreign matters and moistures enter into the hollow package 51, without losing the visibility of the under surface identification information of the image sensor 2. Further, transparent UV curing resin may be poured into the opening 58 and fixed by UV radiation to seal the opening 58. In addition, as an imaging device 66 shown in FIG. 12, the package body 67 may be formed of a transparent material such as a glass or a plastic, so that the under surface identification information of the image sensor 2 can be visually checked.

As the method for recording the under surface identification information, printing, thermal recording and other methods may be used besides the laser marking and the ink-jet.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A method for recording identification information on semiconductor chips comprising:
a patterning process for making plural shots of exposure on a top surface of a wafer coated with photosensitizing agent, through a mask including a plurality of reticles each of which has a circuit pattern and a top surface identification information, and then developing said wafer to form said circuit patterns and said top surface identification information on a metal layer which is the uppermost part or a part close to the uppermost part of said wafer, said top surface identification information enabling to distinguish said semiconductor chips from each other on the basis of said reticles;
a marking process for recording an under surface identification information on an under surface of said wafer, said under surface identification information enabling to distinguish said semiconductor chips from each other on the basis of said shots; and
a dicing process for cutting said wafer into plural pieces of said semiconductor chips.

2. A method for recording identification information on semiconductor chips claimed in claim 1, wherein said under surface identification information is at least one of a product model number, a lot number, a wafer number and a shot position on said wafer.

3. A method for recording identification information on semiconductor chips claimed in claim 1, wherein each of said top surface identification information and said under surface identification information is letters, numerals, symbols or combinations of them.

4. A method for recording identification information on semiconductor chips claimed in,claim 1, wherein said under surface identification information is plural barcodes arranged along different directions.

5. A method for recording identification information on semiconductor chips claimed in claim 1, wherein said under surface identification information is recorded by a laser marking method.

6. A method for recording identification information on semiconductor chips claimed in claim 1, wherein said under surface identification information is recorded by an ink-jet method in which ink dots are ejected.

7. A method for recording identification information on semiconductor chips claimed in claim 6, wherein said ink has heat-resistance and water-resistance

8. A method for recording identification information on semiconductor chips claimed in claim 1, wherein said semiconductor chips are image sensor chips.

9. A method for recording identification information on semiconductor chips claimed in claim 8, wherein said image sensor chips are CCD type image sensor chips.

10. A method for recording identification information on semiconductor chips claimed in claim 8, wherein said image sensor chips are CMOS type image sensor chips.

11. An imaging device comprising:
an image sensor chip having a top surface provided with a light receiving section and an under surface on which identification information is recorded;
a package body having a chip chamber on a top surface thereof, said chip chamber containing said image sensor chip;
an opening penetrating through between an under surface of said package body and a bottom surface of said chip chamber, said identification information being visible through said opening; and
a transparent cover for sealing said chip chamber.

12. An imaging device claimed in claim 11, wherein said opening is sealed with a transparent sealing plate.

13. An imaging device claimed in claim 11, wherein said opening is sealed by transparent UV curing resin which is poured into said opening and then fixed by UV radiation.

14. An imaging device comprising:
an image sensor chip having a top surface provided with a light receiving section and an under surface on which identification information is recorded; and
a package containing said image sensor chip, and being formed of a transparent material, said identification information being visible through said material.

15. An imaging device claimed in claim 14, wherein said package comprising:
a package body having a chip chamber on a top surface thereof, said chip chamber containing said image sensor chip; and
a transparent cover for sealing said chip chamber.
